(19) United States
(12) Patent Application Publication
(10) Pub. No.: US 2020/0088912 A1
(43) Pub. Date: Mar. 19, 2020

(54) POLARIZER AND DISPLAY DEVICE

(71) Applicants: CHONGQING HKC OPTOELECTRONICS TECHNOLOGY CO., LTD., Chongqing (CN); HKC CORPORATION LIMITED, Shenzhen, Guangdong (CN)

(72) Inventor: Mengtao Li, Chongqing (CN)

(21) Appl. No.: 16/312,747

(22) PCT Filed: Nov. 28, 2018
(86) PCT No.: PCT/CN2018/117941

§ 371 Date: Dec. 21, 2018

(30) Foreign Application Priority Data
Sep. 14, 2018 (CN) 201821535342.3

(51) Int. Cl. G02B 1/14; G02B 5/30

(52) U.S. Cl. CPC G02B 1/14; G02B 5/3025

(57) ABSTRACT

A polarizer and a display device; wherein the polarizer includes a polarizer substrate, a first protective layer, a second protective layer and a flexible adhesive layer. According to this arrangement, on one hand, the second protective layer may be adhered on the display substrate through the flexible adhesive layer; on the other hand, when the second protective layer needs to be separated from the display substrate, at this moment, light illumination may be performed, so that the flexible adhesive layer generates a cross-linking reaction under light irradiation and then is removed, a rapidly separating the second protective layer from the display substrate is realized.

### CROSS-REFERENCE TO RELATED APPLICATION

This application is the PCT Application No. PCT/CN2018/117941 for entry into US national phase, with an international filing date of Nov. 28, 2018 designating US, now pending, and claims priority to Chinese Patent Application No. 201821535342.3, filed on Sep. 14, 2018, and titled “polarizer and display device”, the content of which is incorporated herein by reference in its entirety.

### TECHNICAL FIELD

The present disclosure pertains to the technical field of display device, and more particularly to a polarizer and a display device.

### BACKGROUND

The statements herein only provide background information related to the present disclosure without necessarily constituting the prior art. A polarizer is an important part of TFT-LCD (Thin Film Transistor Liquid Crystal Display), that is, the polarizer may absorb light in a vertical direction of polarization axis to allow light transmission in the direction of polarization axis.

However, poor adhesive quality of polarizer often occurs due to machine table faults or human factors in the production process, therefore, the poor polarizer needs to be replaced by a new polarizer; however, the product is caused to be scrapped easily in a replacement process of the polarizer since it is difficult to remove the polarizer, and thus manpower and material resources are wasted.

### SUMMARY

An object of the present disclosure is to provide a polarizer, which solves technical problems including but is not limited to a technical problem that a product is prone to be scrapped in a replacing process of the polarizer.

Embodiments of the present disclosure provide a polarizer, including:

a polarizer substrate;

a first protective layer arranged on one side of the polarizer substrate, and configured to support and protect the polarizer substrate;

a second protective layer arranged on the other side of the polarizer substrate and configured to support and protect the polarizer substrate; and

a flexible adhesive layer configured to be arranged on the second protective layer, where the flexible adhesive layer is made of a material which is de-viscous through light irradiation.

In one embodiment, the flexible adhesive layer is a thin film which is prepared by an UV de-viscous glue.

In one embodiment, the flexible adhesive layer is bonded, hot pressing, printed or coated on the second protective layer.

In one embodiment, the flexible adhesive layer is arranged to be transparent.

In one embodiment, a thickness of the flexible adhesive layer is between 1-2 mm.

In one embodiment, the flexible adhesive layer is arranged to be formed as rectangular or square.

In one embodiment, a thickness of the first protective layer is greater than or equal to a thickness of the polarizer substrate.

In one embodiment, a thickness of the second protective layer is greater than or equal to a thickness of the polarizer substrate.

In one embodiment, the polarizer further includes a separation film configured to protect the flexible adhesive layer, and the separation film is arranged on one side of the flexible adhesive layer opposite to the polarizer substrate.

In one embodiment, the separation film is adhered on the flexible adhesive layer.

In one embodiment, a thickness of the separation film is smaller than or equal to a thickness of the flexible adhesive layer.

In one embodiment, the polarizer further includes a protective film configured to protect the polarizer substrate, where the protective film is arranged on one side of the first protective layer opposite to the polarizer substrate.

In one embodiment, a thickness of the protective film is smaller than or equal to a thickness of the first protective layer.

In one embodiment, the protective film is adhered on the first protective layer.

Another object of the present disclosure is to provide a polarizer, including:

a polarizer substrate;

a first protective layer arranged on one side of the polarizer substrate, and configured to support and protect the polarizer substrate;

a second protective layer arranged on the other side of the polarizer substrate and configured to support and protect the polarizer substrate; and

a flexible adhesive layer configured to be arranged on the second protective layer, to adhere the second protective layer on a display substrate, and to implement de-viscosity and separation of the adhered second protective layer from the display substrate through light irradiation;

where the flexible adhesive layer is a thin film which is prepared by an UV de-viscous glue, and a thickness of the flexible adhesive layer is about 1.5 mm.

Another object of the present disclosure is to provide a display device, including a display host and a base configured to support the display host, where the display host includes a display substrate and a polarizer arranged on the display substrate, and the polarizer includes:

a polarizer substrate;

a first protective layer arranged on one side of the polarizer substrate, and configured to support and protect the polarizer substrate;

a second protective layer arranged on the other side of the polarizer substrate and configured to support and protect the polarizer substrate; and

a flexible adhesive layer, which is a thin film capable of implementing de-viscosity through light irradiation and is configured to be arranged on the second protective layer, to adhere the second protective layer on a display substrate, and to implement de-viscosity and separation of the adhered second protective layer from the display substrate through light irradiation.

In one embodiment, a thickness of the flexible adhesive layer is about 1.5 mm.

In the polarizer provided by the embodiments of the present disclosure, by arranging the flexible adhesive layer between the second protective layer and the display substrate, on one hand, the second protective layer may be adhered on the display substrate through the flexible adhesive layer, on the other hand, when the second protective layer needs to be separated from the display substrate, at this moment, light illumination may be performed, the flexible adhesive layer generates a cross-linking reaction under light irradiation and then is removed, rapidly separating the second protective layer from the display substrate is realized, and rapidly separating the polarizer from the display substrate is further realized; a problem that a polarizer product is caused to be scrapped in the replacement process of the polarizer is avoided, and the cost is reduced.

### BRIEF DESCRIPTION OF THE DRAWINGS

In order to explain this embodiments of the present disclosure more clearly, a brief introduction regarding the accompanying drawings that need to be used for describing the embodiments is given below; it is obvious that the accompanying drawings described as follows are only some embodiments of the present disclosure, for ordinarily skilled one in the art, other drawings may also be obtained according to the current drawings on the premise of paying no creative labor.

FIG. 1 illustrates a structural schematic diagram of a polarizer provided by an embodiment of the present disclosure, where the polarizer has a first protective layer and a second protective layer;

FIG. 2 illustrates a structural schematic diagram of a flexible adhesive layer provided by an embodiment of the present disclosure;

FIG. 3 illustrates a structural schematic diagram of a polarizer provided by an embodiment of the present disclosure, where the polarizer has a separation film;

FIG. 4 illustrates a structural schematic diagram of a polarizer provided by an embodiment of the present disclosure, where the polarizer has a protective film;

FIG. 5 illustrates a structural schematic diagram of a polarizer and a display substrate provided by an embodiment of the present disclosure; and

FIG. 6 illustrates a structural schematic diagram of a display device provided by an embodiment of the present disclosure.

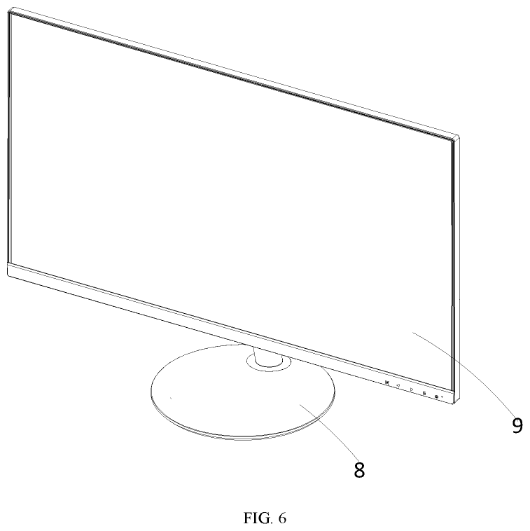

### DESCRIPTION OF THE EMBODIMENTS

In order to make the purpose, the technical solution and the advantages of the present disclosure be clearer and more understandable, the present disclosure is further described in detail below with reference to accompanying figures and embodiments. It should be understood that the specific embodiments described herein are merely intended to illustrate but not to limit the present disclosure.

It should be noted that, when one component is described to be “fixed to” or “arranged on” another component, this component may be directly or indirectly arranged on another component. When one component is described to be “connected with” another component, it may be directly or indirectly connected to the other component. Orientation or position relationships indicated by terms including “upper”, “lower”, “left” and “right” are based on the orientation or position relationships shown in the accompanying figures and is only used for the convenience of description, instead of indicating or implying that the indicated device or element must have a specific orientation and is constructed and operated in a particular orientation, and thus should not be interpreted as limitation to the present disclosure. For the person of ordinary skill in the art, the specific meanings of the aforesaid terms may be interpreted according to specific conditions. Terms of “the first” and “the second” are only for the purpose of describing conveniently and should not be interpreted as indicating or implying relative importance or impliedly indicating the number of indicated technical features. “Multiple/a plurality of” means two or more unless there is an additional explicit and specific limitation.

In order to explain the technical solution of the present disclosure, a detailed description will be given below with reference to the specific accompanying figures and the embodiments.

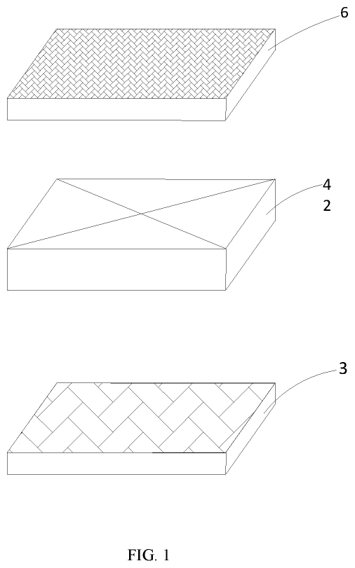

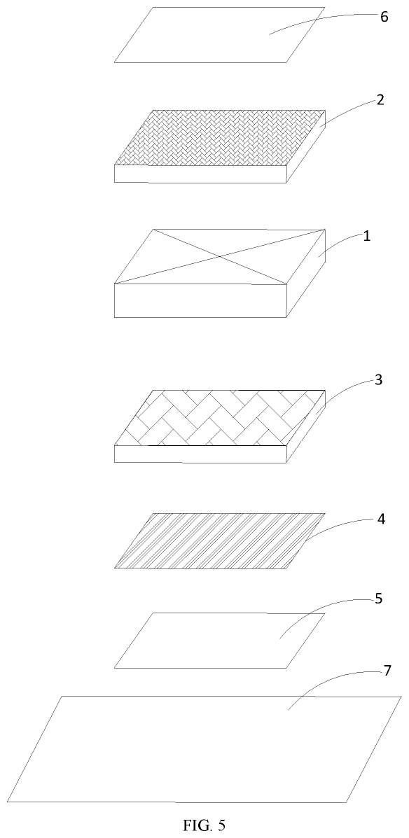

As shown in FIGS. 1-5, an embodiment of the present disclosure provides a polarizer which includes a polarizer substrate 1, an upper surface and a lower surface of the polarizer substrate 1 are respectively provided with a first protective layer 2 and a second protective layer 3, and the first protective layer 2 and the second protective layer 3 are symmetrically arranged on the polarizer substrate 1 respectively; the second protective layer 3 is provided thereon with a flexible adhesive layer 4, and the flexible adhesive layer 4 is adhered with the display substrate 7; in this way, by arranging the flexible adhesive layer 4 between the second protective layer 3 and the display substrate 7, on one hand, the second protective layer 4 may be adhered on the display substrate 7 through the flexible adhesive layer 4, on the other hand, when the second protective layer 3 needs to be separated from the display substrate 7, at this moment, light irradiation may be performed, so that the flexible adhesive layer 4 generates a cross-linking reaction under light irradiation and then is removed, rapidly separating the second protective layer 3 from the display substrate 7 is realized, and rapidly separating the polarizer from the display substrate 7 is further realized, a problem that a polarizer product is caused to be scrapped in the replacement process of the polarizer is avoided, and the cost is reduced. In addition, a mechanical property of the polarizer substrate 1 is enhanced according to the arrangement of the first protective layer 2 and the second protective layer 3, so that the polarizer has certain strong toughness.

In one embodiment, the flexible adhesive layer 4 is prepared from a thin film which is made of a UV (Ultraviolet) glue for de-viscosity, in this way, the flexible adhesive layer 4 is arranged to be an UV glue layer for de-viscosity, so that the flexible adhesive layer 4 may generate a cross-linking reaction through UV light irradiation and thus is prone to be removed. In addition, a crystal structure in the polarizer substrate 1 may not be influenced by the UV light irradiation, and it is ensured that an operational performance of the polarizer substrate 1 would not be affected. Of course, in this embodiment, the flexible adhesive layer 4 may also be prepared from acrylic resin or photoinitiator material, which is not solely limited herein.

In one embodiment, the flexible adhesive layer 4 is adhered on the second protective layer 3, so that the flexible adhesive layer 4 may be quickly arranged on the second protective layer 3, and a production efficiency is improved; of course, in this embodiment, the flexible adhesive layer 4 may also be arranged on the second protective layer 3 through hot pressing, printing, coating and the like, which is not solely limited herein.

In one embodiment, the flexible adhesive layer 4 is arranged to be transparent, such that a transmittance of light irradiation may be enhanced, and an effect of de-viscosity is better in a de-viscosity process; of course, in this embodiment, the flexible adhesive layer 4 may also be arranged to be semi-transparent or the like according to an actual condition and a specific requirement, which is not solely limited herein.

In one embodiment, a thickness of the flexible adhesive layer 4 is arranged to be 1-2 mm, such that the flexible adhesive layer 4 may be ensured to have certain viscosity; meanwhile, an increment of manufacturing cost due to too large thickness of the flexible adhesive layer 4 may be avoided. Of course, in this embodiment, the flexible adhesive layer 4 may also be arranged to have other thicknesses or the like according to the actual condition and the specific requirement, which is not solely limited herein.

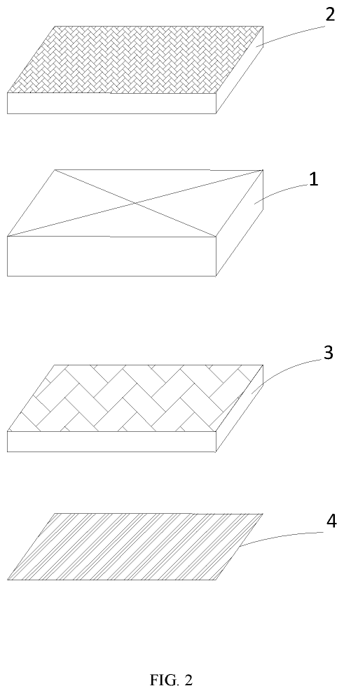

In one embodiment, referring to FIG. 2, the flexible adhesive layer 4 is arranged to be formed as rectangular or square, in this way, it is guaranteed that the flexible adhesive layer 4 has a large surface area, so that the second protective layer 3 may be adhered on the display substrate 7 better, and an adhesion force of the flexible adhesive layer 4 is increased. Of course, in this embodiment, the flexible adhesive layer 4 may also be arranged to be formed as other shape such as a circle, which is not solely limited herein. In one embodiment, the first protective layer 2 may be covered on the polarizer substrate 1 in a bonding manner; in this way, on one hand, arranging the first protective layer 2 on the polarizer substrate 1 may be implemented, on the other hand, when the first protective layer 2 is damaged, the first protective layer 2 may be detached and replaced conveniently. Of course, in this embodiment, the first protective layer 2 may also be on the polarizer substrate 1 through hot pressing, printing, coating and the like, which is not solely limited herein.

In one embodiment, the second protective layer 3 may be covered on the polarizer substrate 1 in a bonding manner, in this way, on one hand, arranging the second protective layer 3 on the polarizer substrate 1 may be implemented, on the other hand, when the second protective layer 3 is damaged, the second protective layer 3 may be detached and replaced conveniently. Of course, in this embodiment, the second protective layer 3 may also be arranged on the polarizer substrate 1 through hot pressing, printing, coating, or the like, which is not solely limited herein.

In one embodiment, a thickness of the first protective layer 2 is greater than a thickness of the polarizer substrate 1. In this way, the thickness of the first protective layer 2 is arranged to be greater than the thickness of the polarizer substrate 1, so that the polarizer substrate 1 may be well supported and protected by the first protective layer 2. Of course, in this embodiment, the thickness of the first protective layer 2 may also be equal to or smaller than the thickness of the polarizer substrate 1 according to the actual condition and the specific requirement, which is not solely limited herein.

In one embodiment, a thickness of the second protective layer 3 is greater than the thickness of the polarizer substrate 1. In this way, the thickness of the second protective layer 3 is arranged to be greater than the thickness of the polarizer substrate 1, so that the polarizer substrate 1 may be well supported and protected by the second protective layer 2. Of course, in this embodiment, the thickness of the second protective layer 3 may also be smaller than or equal to the thickness of the polarizer substrate 1 according to the actual condition and the specific requirement, which is not solely limited herein.

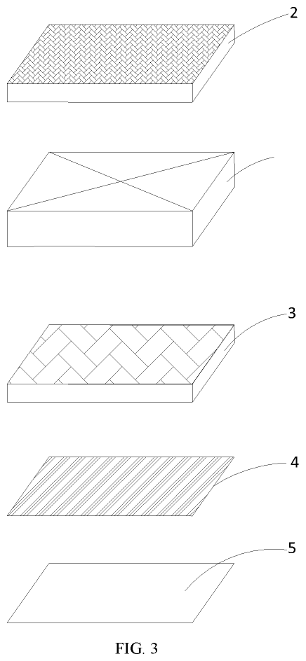

In one embodiment, referring to FIG. 3, the aforesaid polarizer is further provided thereon with a layer of separation film 5, and the separation film 5 is arranged on one side of the flexible adhesive layer 4 opposite to the polarizer substrate 1, the flexible adhesive layer 4 may be protected from being contaminated by external environment according to the arrangement of separation film 5. Of course, in this embodiment, the separation film 5 may also be arranged on the flexible adhesive layer 4 in other manners, which is not solely limited herein.

In this embodiment, when the flexible adhesive layer 4 needs to be used, at this time, the separation film 5 may be peeled off, so that the flexible adhesive layer 4 may be adhered on the display substrate 7, so that the entire of the polarizer is further arranged on the aforesaid display substrate 7; when the polarizer needs to be replaced, the flexible adhesive layer 4 may be removed through light irradiation, and separating the polarizer from the display substrate 7 is realized.

In one embodiment, a thickness of the separation film 5 is smaller than the thickness of the flexible adhesive layer 4, on one hand, the flexible adhesive layer 4 may be protected from being contaminated by external environment; on the other hand, an increment of manufacturing cost due to too large thickness of the separation film 5 may also be avoided. Of course, in this embodiment, the separation film 5 may also be arranged to be equal to the thickness of the flexible adhesive layer 4 according to the actual condition and the specific requirement, which is not solely limited herein.

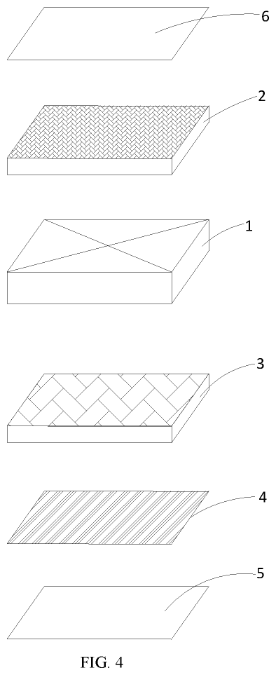

In one embodiment, referring to FIG. 4, the polarizer in the present disclosure is further provided thereon with a protective film 6, and the protective film 6 is arranged on the first protective layer 3; optionally, the protective film 6 is arranged on one side of the first protective layer 3 opposite to the polarizer substrate 1; in this way, the polarizer substrate 1 is further protected according to the arrangement of the protective film 6, and the polarizer substrate 1 is prevented from being contaminated by external environment. Optionally, the protective film 6 is adhered with the first protective layer 2. Of course, the first protective layer 2 may also be arranged on the first protective layer 2 in other manners, which is not solely limited herein.

In one embodiment, a thickness of the protective film 6 is smaller than the thickness of the first protective layer 2, in this way, on one hand, the first protective layer 2 may be protected from being contaminated, on the other hand, the polarizer may become more thinned. Of course, in this embodiment, the thickness of the protective film 6 may also be arranged to be greater than or equal to the thickness of the aforesaid first protective layer 2, which is not solely limited herein.

In one embodiment, the aforesaid protective film 6 is adhered with the first protective layer 2, in this way, the protective film 6 may be arranged on the first protective layer 2 quickly, when the protective film 6 is damaged, the protective film 6 may be detached and replaced conveniently. Of course, in this embodiment, the protective film 6 may also be arranged on the first protective layer 2 in other manners, which is not solely limited herein.

In another embodiment, a polarizer is provided, the polarizer includes a polarizer substrate 1, an upper surface and a lower surface of the polarizer substrate 1 are provided with a first protective layer 2 and a second protective layer 3 respectively, and the first protective layer 2 and the second protective layer 3 are symmetrically arranged on the polarizer substrate 1 respectively, a flexible adhesive layer 4 is arranged on the second protective layer 3, the flexible adhesive layer 4 is adhered with the display substrate 7, and the flexible adhesive layer 4 is a thin film made of UV light adhesive for de-viscosity. In this way, according to the flexible adhesive layer 4 arranged between the second protective layer 3 and the display substrate 7, and the thickness of the flexible adhesive layer is about 1.5 mm, on one hand, the second protective layer 3 may be adhered on the display substrate 7 through the flexible adhesive layer 4; on the other hand, when the second protective layer 3 needs to be separated from the display substrate 7, at this moment, light irradiation may be performed, the flexible adhesive layer 4 generates a cross-linking reaction under light irradiation and then is removed, so that rapidly separating the second protective layer 3 from the display substrate 7 is implemented, and rapidly separating the polarizer from the display substrate 7 is further realized, and a problem that the polarizer product is caused to be scrapped in a replacement process of the polarizer is avoided, and the cost is reduced. A mechanical property of the polarizer substrate 1 may be enhanced according to the arrangement of the first protective layer 2 and the second protective layer 3, such that the polarizer has certain strong toughness. In addition, the flexible adhesive layer 4 is arranged to be the UV light glue layer for de-viscosity, so that the flexible adhesive layer 4 may generate the cross-linking reaction through UV light irradiation and thus is prone to be removed. In addition, a crystal structure in the polarizer substrate 1 may not be influenced by the UV light irradiation, and it is ensured that the operational performance of the polarizer substrate 1 would not be affected.

In one embodiment, the flexible adhesive layer 4 is covered on the second protective layer 3 in the manner of bonding, hot pressing, printing and the like, in this way, the flexible adhesive layer 4 may be affixed on the second protective layer 3 better. Of course, the flexible adhesive layer 4 may be covered on the second protective layer 3 in other manners, which is not solely limited herein.

In this embodiment, a display device is further provided, this display device includes a display host 9 and a base 8, and the base 8 may be configured to support the display host 9; in particular, the display host 9 includes a display substrate 7, and the display substrate 7 is provided thereon with a polarizer, and the polarizer is the one described above, it is not repeatedly described herein.

In this embodiment, according to the arrangement of the flexible adhesive layer 4 prepared from the UV de-viscosity glue, in this way, the flexible adhesive layer 4 may generate the cross-linking reaction through UV light irradiation and thus is prone to be removed on the premise that the operational performance of the polarizer substrate 1 is guaranteed, rapidly separating the polarizer from the display substrate 7 is further realized, and the problem that the polarizer product is caused to be scrapped in the replacement process of the polarizer is avoided, and the production cost is reduced.

The foregoing is only optional embodiments of the present disclosure and are not intended to limit the present disclosure. For ordinarily skilled one in the art, there may be various modifications and variations in the present disclosure. Any modification, equivalent replacement, improvement, and the like, which are made within the spirit and the principle of the present disclosure, should all be included in the protection scopes of the claims of the present disclosure.

1. A polarizer, comprising:
a polarizer substrate;
a first protective layer arranged on one side of the polarizer substrate, and configured to support and protect the polarizer substrate;
a second protective layer arranged on the other side of the polarizer substrate and configured to support and protect the polarizer substrate; and
a flexible adhesive layer configured to be arranged on the second protective layer, wherein the flexible adhesive layer is made of a material which is de-viscous through light irradiation.

2. The polarizer according to claim 1, wherein the flexible adhesive layer is a thin film which is prepared by an UV de-viscous glue.

3. The polarizer according to claim 1, wherein the flexible adhesive layer is bonded, hot pressing, printed or coated on the second protective layer.

4. The polarizer according to claim 1, wherein the flexible adhesive layer is arranged to be transparent.

5. The polarizer according to claim 4, wherein a thickness of the flexible adhesive layer is between 1-2 mm.

6. The polarizer according to claim 5, wherein the flexible adhesive layer is arranged to be formed as rectangular or square.

7. The polarizer according to claim 1, wherein a thickness of the first protective layer is greater than or equal to a thickness of the polarizer substrate.

8. The polarizer according to claim 1, wherein a thickness of the second protective layer is greater than or equal to a thickness of the polarizer substrate.

9. The polarizer according to claim 1, wherein the polarizer further comprises a separation film configured to protect the flexible adhesive layer, and the separation film is arranged on one side of the flexible adhesive layer opposite to the polarizer substrate.

10. The polarizer according to claim 9, wherein the separation film is adhered on the flexible adhesive layer.

11. The polarizer according to claim 9, wherein a thickness of the separation film is smaller than or equal to a thickness of the flexible adhesive layer.

12. The polarizer according to claim 1, wherein the polarizer further comprises a protective film configured to protect the polarizer substrate, wherein the protective film is arranged on one side of the first protective layer opposite to the polarizer substrate.

13. The polarizer according to claim 12, wherein a thickness of the protective film is smaller than or equal to a thickness of the first protective layer.

14. The polarizer according to claim 12, wherein the protective film is adhered on the first protective layer.

15. A polarizer, comprising:
a polarizer substrate;
a first protective layer arranged on one side of the polarizer substrate, and configured to support and protect the polarizer substrate;
a second protective layer arranged on the other side of the polarizer substrate and configured to support and protect the polarizer substrate; and
a flexible adhesive layer configured to be arranged on the second protective layer, to adhere the second protective layer on a display substrate, and to implement de-viscosity and separation of the adhered second protective layer from the display substrate through light irradiation;
wherein the flexible adhesive layer is a thin film which is prepared by an UV de-viscous glue, and wherein a thickness of the flexible adhesive layer is about 1.5 mm.

16. A display device, comprising a display host and a base configured to support the display host, wherein the display host comprises a display substrate and a polarizer arranged on the display substrate, and the polarizer comprises:
a polarizer substrate;
a first protective layer arranged on one side of the polarizer substrate, and configured to support and protect the polarizer substrate;
a second protective layer arranged on the other side of the polarizer substrate and configured to support and protect the polarizer substrate; and
a flexible adhesive layer, which is a thin film capable of implementing de-viscosity through light irradiation and is configured to be arranged on the second protective layer, to adhere the second protective layer on a display substrate, and to implement de-viscosity and separation of the adhered second protective layer from the display substrate through light irradiation.

17. The display device according to claim 16, wherein a thickness of the flexible adhesive layer is about 1.5 mm.
